(19) United States
(12) Patent Application Publication
(10) Pub. No.: US 2026/0318091 A1
(43) Pub. Date: Oct. 15, 2026

(54) Assembly Platform for Supporting a Person When Carrying Out a Working Process on a Vehicle and Use of Such an Assembly Platform

(71) Applicant: Mercedes-Benz Group AG, Stuttgart (DE)

(72) Inventors: Willi BAUER, Rottenburg am Neckar (DE); Oliver KERN, Kornwestheim (DE)

(21) Appl. No.: 19/476,974

(22) PCT Filed: Feb. 21, 2024
(86) PCT No.: PCT/EP2024/054341

§ 371 Date: Oct. 20, 2025

(30) Foreign Application Priority Data
Apr. 21, 2023 (DE) 10 2023 001 601.2

(51) Int. Cl. E04G 1/30; E04G 1/15; E04G 1/22; E04G 7/00

(52) U.S. Cl. CPC E04G 1/30; E04G 1/15; E04G 1/22; E04G 7/00; E04G 2001/305

(57) ABSTRACT

An assembly platform for supporting a person when carrying out at least one working process on a vehicle has a base frame which has a holding frame with a frame fastening device and support elements moveably held on the holding frame via which support elements the holding frame and thus the assembly platform can be supported downwards on a floor in the vertical direction. At least two platforms are provided which are formed separately from one another and separately from the base frame and are provided to support the person, each of which having a platform fastening device, where optionally only one of the platforms or the at least two platforms can be releasably non-destructively fastened to the holding frame by the frame fastening device and the respective platform fastening device.

### BACKGROUND AND SUMMARY OF THE INVENTION

The invention relates to an assembly platform for supporting a person when carrying out at least one working process on a vehicle, in particular on a motor vehicle. Furthermore, the invention relates to a use of such an assembly platform.

A transport system for a production line is known from DE 10 2018 130 221A1, having at least two driverless transport vehicles, which each have a walkable assembly platform, at least one receiving device for a component each, and their own drive by means of which the respective transport vehicle can be moved. DE 20 2015 002 163 U1 discloses a work platform. DE 10 2007 063 069 A1 discloses an assembly platform for motor vehicles. DE 10 2021 128 813 A1 discloses a method for producing body shells for a motor vehicle. DE 10 2018 130 221 A1 discloses a transport system for a production line.

The object of the present invention is to create an assembly platform and a use of such an assembly platform, such that at least one working process can be carried out particularly advantageously on a vehicle with the aid of the assembly platform.

A first aspect of the invention relates to an assembly platform for supporting a person when carrying out at least one working process on a vehicle, in particular on a motor vehicle. This means that the assembly platform can be used in order to support the person when carrying out the at least one working process. In other words, the person can particularly advantageously, in particular ergonomically, carry out the at least one working process on the vehicle with the aid of the assembly platform. The at least one working process can, for example, comprise at least one repair process for repairing the vehicle. Alternatively or additionally, the at least one working process can, for example, comprise at least one maintenance process, also referred to as a servicing process, by which the vehicle is serviced. Furthermore, it is alternatively or additionally conceivable for the at least one working process to comprise at least one diagnostic process, by which, for example, the vehicle is checked. In particular, the diagnostic process can comprise a fault memory of the vehicle, in particular an electrical or electronic fault memory, being read, for example by means of an electronic computing device. For example, the assembly platform can be used to support the person when carrying out the at least one working process in such a way that the person lies, kneels, and/or sits on the assembly platform while carrying out the at least one working process and is thus comfortably and ergonomically supported downwards in the vertical direction on a floor via the assembly platform while the person carries out the at least one working process. The at least one work process can comprise at least or exactly one work step or several, in particular chronologically sequential, work steps.

The assembly platform according to the invention has a base frame, also referred to as a base or basic frame, which has a holding frame, also referred to simply as a frame, and movable, in particular pivotable, support elements held on the holding frame, which are also referred to as feet or pedestals. For example, the respective support element is coupled to the holding frame so as to be pivotable around a respective pivot axis relative to the holding frame, such that, for example, the respective support element can be pivoted around the pivot axis relative to the holding frame between a stowed position and at least one use position. The respective use position and the respective stowed position of the respective support element are collectively also referred to as positions, wherein it is preferably provided that the respective support element can be locked, i.e., fixed, in the respective position relative to the holding frame. For this purpose, for example a locking device is provided, for example, provided partially on the holding frame and partially on the respective support element, by means of which the respective support element can be locked, i.e., fixed, in the respective position relative to the holding frame. In particular, it is provided, for example, that the respective support element is folded onto or against the holding frame in the respective stowed position, wherein the respective support element is folded away from the holding frame in the respective use position, in particular relative to the respective stowed position, and thus unfolded. The holding frame and thus the assembly platform as a whole can be supported downwards in the vertical direction on the aforementioned floor via the support elements. In its state supported downwards in the vertical direction on the floor via the support elements, the assembly platform assumes its use position, which is a position or orientation of the assembly platform provided for its intended use. Here, the assembly platform is brought into the use position in order to support the person in carrying out the at least one working process, such that the person carries out the at least one working process with the aid of the assembly platform while the assembly platform is in the use position.

Moreover, the assembly platform has at least or exactly two, in particular more than two and here, for example, at least or exactly three, platforms formed separately from one another and separately from the base frame and provided for supporting the person. The respective platform is a respective plate and has an at least substantially two-dimensional extension, in particular in such a way that the respective platform has, for example, a first extension, a second extension running perpendicular to the first extension, and a third extension running perpendicular to the first extension and perpendicular to the second extension and referred to, for example, as the thickness, wherein the first extension and the second extension are each substantially larger than the third extension. The feature that the respective platform is provided for supporting the person is to be understood as meaning that the respective platform can support the person, in particular in downwards in the vertical direction, while carrying out the at least one working process and thus when the assembly platform is in its use position. Thus, for example, the person can kneel, sit, stand, or lie on the respective platform while they carry out the at least one working process and thus ergonomically support themselves downwards on the floor in the vertical direction via the assembly platform. Thus, the person can carry out the at least one working process particularly advantageously, in particular particularly ergonomically.

The support frame has a first fastening device, which is also referred to as a frame fastening device. The respective platform has a respective second fastening device, which is also referred to as a platform fastening device. The respective platform can be fastened to the holding frame, in particular independently of the respective other platform, by means of the respective platform fastening device of the respective platform and by means of the frame fastening device of the holding frame, wherein it is provided in the assembly platform according to the invention, that either only one, i.e., exactly one of the platforms, or both, in particular all, platforms of the assembly platform can be non-destructively releasably fastened to the support frame simultaneously by means of the frame fastening device and the respective platform fastening device. This means that at least two variants of the assembly platform, also referred to as construction variants, can be implemented. In a first of the variants, only, i.e., exactly one of the platforms, is non-destructively releasably fastened to the support frame by means of the platform fastening device of the one platform and by means of the frame fastening device, such that the first variant comprises the base frame and, with respect to the platforms, only one of the platforms. In a second of the variants, both, in particular all, platforms of the assembly platform are non-destructively releasably fastened to the support frame by means of the platform fastening devices and by means of the frame fastening device, such that the second variant comprises the base frame and the at least two platforms. The assembly platform thus has a modular construction and can thus be easily, quickly, and cost-effectively adjusted to a respective working process that can be carried out with the aid of the assembly platform, such that the person can carry out the respective working process particularly ergonomically. In particular, the invention enables the person to ergonomically reach normally hard-to-reach areas in the respective engine compartment of the vehicle by means of the assembly platform and thus to be able to carry out the at least one working process in the engine compartment. Damage to the vehicle can be avoided since the person does not come into contact with the vehicle or parts of the vehicle when using the assembly platform and carrying out the at least one working process. Due to the modular construction of the assembly platform according to the invention, the assembly platform can be used cost-effectively for different model series. Damage to components of the vehicle can be avoided, and the assembly platform enables ergonomic working, thus ergonomic performance of the at least one working process. Furthermore, the assembly platform according to the invention enables safe working, since unnecessary contact between the person and the vehicle can be avoided, which is particularly advantageous when the vehicle, for example formed as a passenger car, is formed as a hybrid vehicle or electric vehicle and thus has high-voltage components whose respective electrical voltage, in particular electrical operating or nominal voltage, is for example greater than 50 volts, in particular greater than 60 volts, and in particular amounts to several hundred volts.

In the invention, the respective platform extends elongately, in particular in a first spatial direction, and thus has a respective longitudinal direction of extension. For example, the aforementioned first extension of the respective platform runs in the first spatial direction. For example, the aforementioned second extension extends in a second spatial direction, which runs perpendicularly to the first spatial direction, and for example, the aforementioned third extension extends in a third spatial direction, which runs perpendicularly to the first spatial direction and perpendicularly to the second spatial direction. Because the respective platform preferably has a longitudinal direction of extension, thus extending elongately, the person can, for example, be comfortably and ergonomically supported on the respective platform and, via this, on the floor when carrying out the at least one working process, and can subsequently carry out the at least one working process in a particularly ergonomic manner.

Here, it is provided that the respective platform can be fastened to the support frame in its respective longitudinal direction of extension by means of the frame fastening device and the respective platform fastening device in at least two mutually different positions, in particular in more than two mutually different positions. Thus, a particularly advantageous and needs-based positioning of the respective platform can be realized, in particular relative to the support frame and also relative to the vehicle, such that the at least one working process can be carried out particularly comfortably and ergonomically.

In the invention, the respective platform can be fastened to the support frame along a respective direction running perpendicular to the respective longitudinal extension direction and thereby along the second extension or along the second spatial direction by means of the frame fastening device and the respective platform fastening device in at least two mutually different positions, in particular in more than two mutually different positions. It is provided that the first spatial direction and the second spatial direction, and thus the longitudinal extension direction and the aforementioned direction, extend in a common plane. This allows for a particularly needs-based positioning of the respective platform relative to the support frame, so that the assembly platform can be adapted to different work processes particularly easily and cost-effectively. This allows the respective work process to be carried out particularly ergonomically.

In order to be able to adjust the assembly platform to different working processes particularly easily and as required, and thus to enable particularly ergonomic working, it is provided in an embodiment of the invention that the respective platform can be fastened to the holding frame by means of the frame fastening device and the respective platform fastening device in at least two different positions, in particular in more than two different positions.

In order to achieve particularly extensive adaptability of the assembly platform to different working processes and thus to be able to carry out the respective working process in a particularly ergonomic manner, it is provided in a further embodiment of the invention that the respective support element can be changed with respect to its respective length, which runs vertically when the holding frame is supported downwards on the floor via the support elements in a vertical direction, whereby the holding frame is height-adjustable in the vertical direction and relative to the position of use. Thus, the distance between the holding frame and the floor, which runs vertically when the holding frame is supported downwards on the floor via the support elements in a vertical direction, is adjustable.

A further embodiment is characterized in that at least one of the support elements, in particular both support elements, has rungs or steps. In doing so, for example when the assembly platform is in its usage position, the person can access the respective platform attached to the support frame particularly easily and ergonomically via the rungs or steps, in particular by the person climbing or ascending the rungs or steps. This ensures particularly ergonomic working.

Finally, it has proved to be particularly advantageous when the support frame is adjustable in length, such that, for example, a distance between attachment points can be adjusted, i.e., changed, wherein one of the support elements is coupled to the support frame at the respective attachment point. This allows for a particularly extensive, and therefore flexible, adaptability of the assembly platform and different working processes, such that particularly ergonomic and comfortable working can be realized.

A second aspect of the invention relates to a use of an assembly platform according to the first aspect of the invention, wherein the assembly platform is used in order to support a person in performing at least one working process on a vehicle, in particular in such a way that the person is supported downwards in the vertical direction on the ground via the assembly platform. Advantages and advantageous designs of the first aspect of the invention are to be regarded as advantages and advantageous designs of the second aspect of the invention, and vice versa.

In order to be able to carry out the at least one working process particularly comfortably and ergonomically, it is provided in a further design of the invention that the person lies, sits or kneels on at least one of the platforms when carrying out the at least one working process.

For example, the at least one working process is carried out in a workshop, in particular during repairs or maintenance. Here, the assembly platform according to the invention allows the person to ergonomically reach all components of the vehicle relevant for carrying out the at least one working process and thus to be able to carry out the working process particularly advantageously from an ergonomic point of view, in particular without damaging the vehicle. Since either both platforms or only one of the platforms can be attached to the support frame, a particularly advantageous, extensive adjustability of the assembly platform can be realized, such that the assembly platform can be adjusted to different vehicles and/or different working processes. The assembly platform is thus an aid whose height is, for example, universally and preferably mechanically adjustable, i.e., adjustable in the vertical direction, in particular within a range of from 700 millimeters up to and including 1,500 millimeters. Because, for example, the support frame is variable in length, a length of the support frame can be set, in particular within a range of from approximately 1,500 millimeters to 2,200 millimeters, such that the assembly platform is adjustable in width.

Further advantages, features and details of the invention emerge from the description below of a preferred exemplary embodiment and by means of the drawings. The features and feature combinations mentioned above in the description and the features and feature combinations mentioned below in the description of the figures and/or shown only in the figures can be used not only in the respectively specified combination, but also in other combinations or on their own, without leaving the scope of the invention.

### BRIEF DESCRIPTION OF THE DRAWINGS

FIGS. 1a-i are schematic top views of a respective variant of an assembly platform for supporting a person when carrying out at least one working process on a vehicle;

FIG. 2 is a schematic side view of the assembly platform in its usage position; and

FIG. 3 is a schematic side view of the assembly platform its usage position.

### DETAILED DESCRIPTION OF THE DRAWINGS

In the Figures, the same or functionally identical elements are provided with the same reference numbers.

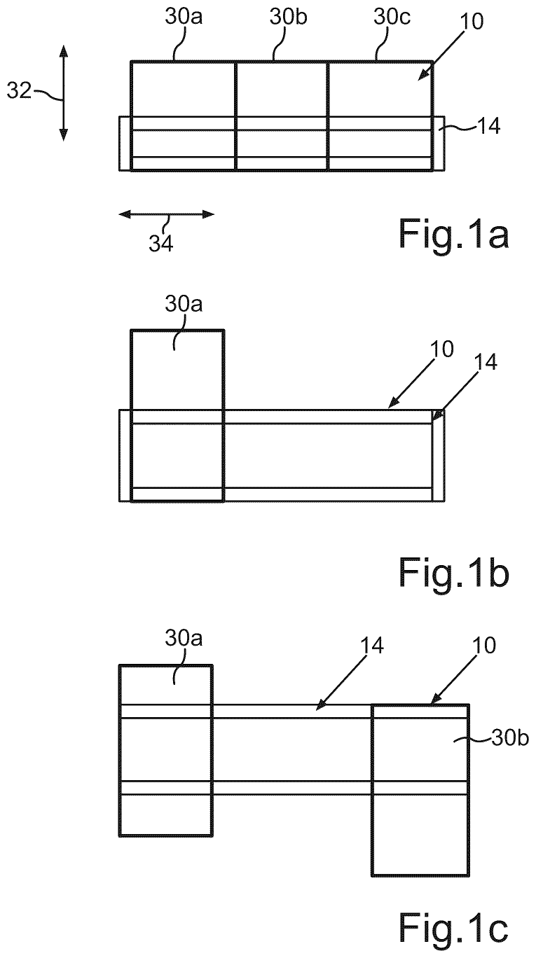

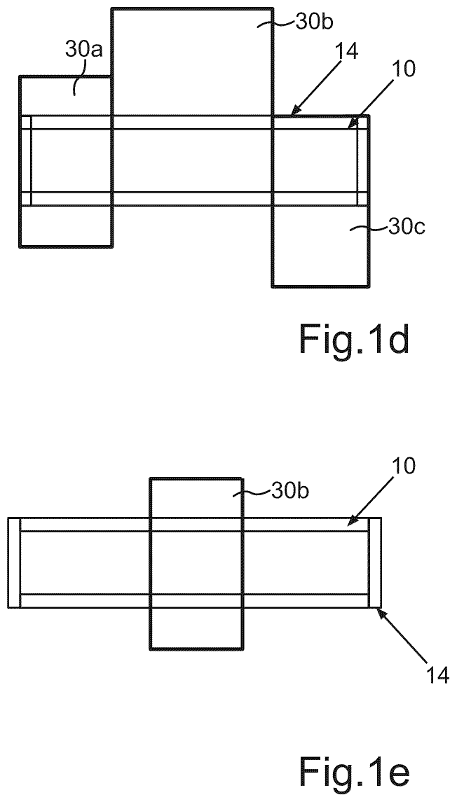

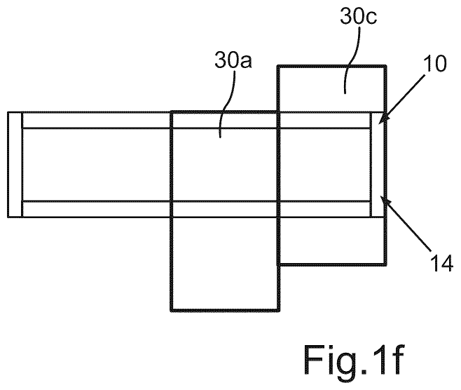

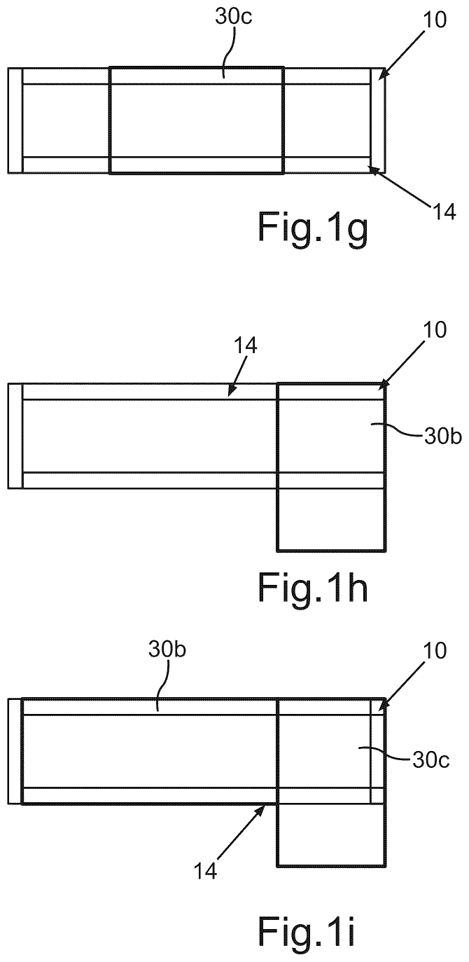

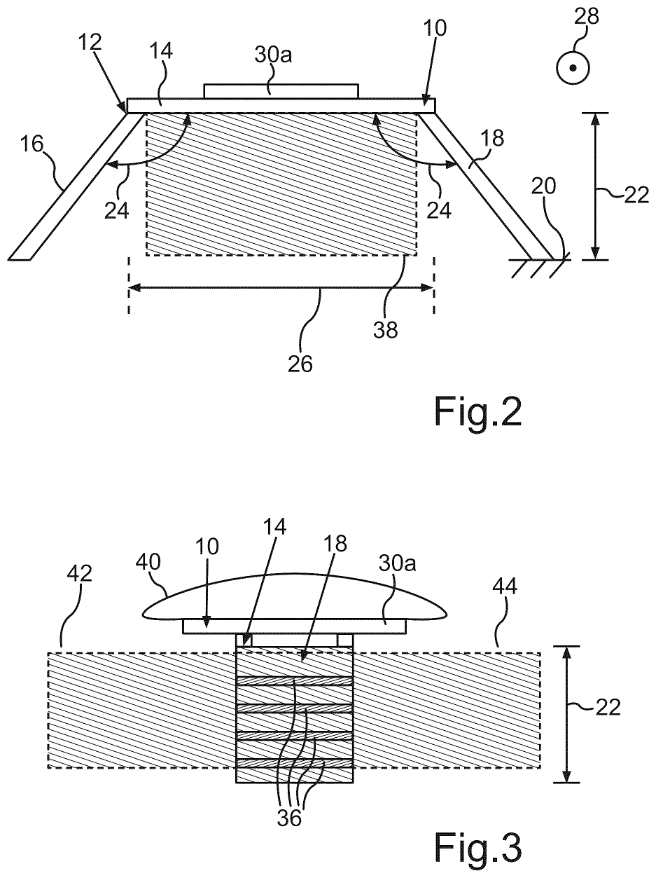

In a schematic top view, FIGS. 1a-i each show a respective variant of an assembly platform 10, which can also be seen particularly clearly in FIGS. 2 and 3, for supporting a person when carrying out at least one working process on a vehicle, which is preferably formed as a motor vehicle, in particular as a passenger car. From looking at FIGS. 1a, 2 and 3 together, it can be seen that the assembly platform 10 has a base frame 12 which has a holding frame 14, also simply referred to as a frame, and support elements 16 and 18 which are moveably, in particular pivotably, held on the holding frame 14 and via which the holding frame 14 and thus the assembly platform 10 can be supported downwards in a vertical direction on a floor 20. In the Figures, the assembly platform 10 is in its usage position, in which the assembly platform 10 is supported downwards in a vertical direction on the floor 20 via the support elements 16 and 18. The vertical direction is illustrated by a double arrow 22. The respective support element 16, 18 is moveably, in particular pivotably, attached to the holding frame 14, also simply referred to as the frame, at a respective fastening point and can thus be moved, in particular pivoted, relative to the holding frame 14 between at least one respective usage position, shown for example in FIG. 2, and a respective stowed position. As illustrated in FIG. 2 by double arrows 24, in the exemplary embodiment shown in the Figures, the respective support element 16, 18 can be pivoted, i.e., folded, relative to the holding frame 14 between the respective stowed position and the respective usage position. In the respective stowed position, the respective support element 16, 18 is folded towards the holding frame 14, in particular folded on or against the holding frame 14. In the respective usage position, the respective support element 16, 18 is folded away from the holding frame 14, i.e., unfolded. For example, the assembly platform 10 has a locking device that is not visible in the Figures, by means of which the respective support element 16, 18 can be locked, and thus fixed, in the respective usage position and also in the respective stowed position relative to the frame (holding frame 14). The fastening points are spaced apart from one another in a first spatial direction, which is illustrated in FIG. 2 by a double arrow 26 and runs perpendicularly to the vertical direction and thus perpendicularly to a second spatial direction illustrated by the double arrow 22. A third spatial direction is illustrated by a double arrow 28, runs perpendicularly to the image plane of FIG. 2, perpendicularly to the first spatial direction and perpendicularly to the second spatial direction, wherein the first spatial direction and the third spatial direction run on a common plane running perpendicularly to the vertical direction. For example, the holding frame 14 is formed to be adjustable in length. This means that the holding frame 14 is formed to be variable, i.e., adjustable, with respect to its length in the second spatial direction (double arrow 26), whereby a distance between the fastening points running in the second spatial direction is adjustable, i.e., changeable. Thus, a width of the assembly platform 10 running in the second spatial direction can be adjusted, i.e., changed.

It can be seen particularly well from FIG. 1a that in the exemplary embodiment shown in the Figures, the assembly platform 10 has at least or exactly three platforms 30a-c which are formed separately from one another and separately from the base frame 12. The frame (holding frame 14) has a first fastening device, not visible in the Figures, which is also referred to as a frame fastening device. The respective platform 30a-c has a respective second fastening device, which is also referred to as a platform fastening device. It can be seen from FIGS. 1a-i that optionally only one of the platforms 30a-c or exactly or only two of the platforms 30a-c at the same time or all three platforms 30a-c at the same time can be non-destructively detachably fastened to the holding frame 14 by means of the frame fastening device and the respective platform fastening device. The feature that the respective platform 30a-c can be detachably and non-destructively fastened to the holding frame 14 by means of the fastening devices is to be understood to mean that the respective platform 30a-c can be fastened to the frame by means of the fastening devices, then detached from the frame and then reconnected to the frame, thus fastened to the frame, without causing destruction or damage to the respective platform 30a-c or the holding frame 14.

FIG. 1a shows a first of the variants of the assembly platform 10. In the first variant, the platforms 30a-c are simultaneously fastened to the holding frame 14 by means of the respective fastening devices. The holding frame, in particular its frame elements, has or have, for example, a U-shape. In the stowed positions of the support elements 16, 18, the support elements 16, 18 are folded against the frame, such that the assembly platform 10 requires only a small amount of installation space and can be easily transported. In particular, it is conceivable that the respective support element 16, 18 can be pivoted relative to the frame into different positions, presently formed as pivot positions, and fixed in the respective position relative to the frame, in particular by means of the locking device, in order to thus adjust the assembly platform 10 easily, as needed, and cost-effectively to different vehicles and/or different working processes. Preferably, the locking device is a mechanical locking device by means of which the respective support element 16, 18 can be mechanically locked relative to the frame. For example, the locking device comprises mechanical fixations for this purpose.

FIG. 1b shows a second of the variants, in which exactly one of the platforms 30a-c, namely in this case the platform 30a, is non-destructively releasably fastened to the holding frame 14, that is by means of the platform fastening device of the platform 30a and by means of the frame fastening device of the holding frame 14. FIG. 1c shows a third of the variants, in which exactly two of the platforms 30a-c, namely, for example, the platforms 30a and 30b, are non-destructively releasably fastened to the holding frame 14. FIG. 1d shows a fourth of the variants, in which all three platforms 30a-c are non-destructively releasably fastened to the holding frame 14. FIG. 1e shows a fifth of the variants, in which exactly one of the platforms 30a-c, for example, the platform 30b, is non-destructively releasably fastened to the holding frame 14. FIG. 1f shows a sixth of the variants, in which exactly two of the platforms 30a-c, for example the platforms 30a and 30c, are non-destructively releasably attached to the holding frame 14. FIG. 1g shows a seventh of the variants, in which exactly one of the platforms 30a-c, for example the platform 30c, is non-destructively releasably attached to the frame (holding frame 14). FIG. 1h shows an eighth of the variants, in which exactly one of the platforms 30a-c, in this case the platform 30b, is non-destructively releasably attached to the holding frame 14. FIG. 1i shows a ninth of the variants, in which exactly two of the platforms 30a-c, in this case the platforms 30b and 30c, are non-destructively releasably attached to the holding frame 14. From FIGS. 1a-i it can be seen that the respective platform 30a-c can be fastened to the holding frame 14 by means of the respective platform fastening device and by means of the frame fastening device in at least two mutually different positions of the respective platform 30a-c.

The respective platform 30a-c extends elongately, in particular in a first direction illustrated by a double arrow 32, such that the respective platform 30a-c has a longitudinal extension direction that coincides with the first direction and is thus illustrated by the double arrow 32. As can be seen from viewing FIGS. 1a-i together, the respective platform 30a-c can be fastened to the holding frame 14 in its respective longitudinal extension direction by means of the frame fastening device and the respective platform fastening device in at least two mutually different positions, in particular in more than two mutually different positions, of the respective platform 30a-c.

The respective platform 30a-c has a respective first extension, also referred to as length, which runs in the first direction. Moreover, the respective platform 30a-c has a respective second extension, which runs in a second direction perpendicular to the first direction and illustrated by a double arrow 34. The first direction and the second direction run on a common plane, which, in the usage position of the assembly platform 10, runs perpendicularly to the vertical direction. Thus, the second extension runs perpendicularly to the longitudinal extension direction of the respective platform 30a-c. Moreover, the respective platform 30a-c has a third extension, which runs perpendicularly to the first extension and perpendicularly to the second extension and thus runs in the vertical direction relative to the usage position. Here, the first extension and the second extension are substantially larger than the third extension, such that the respective platform 30a-c is formed as a surface element.

From viewing FIGS. 1a-i together, it can also be seen that the platform can be fastened to the support frame 14 in its respective second extension, which runs perpendicularly to its respective longitudinal extension direction, and thus in the second direction, by means of the frame fastening device and the respective platform fastening device in at least two mutually different positions of the respective platform 30a-c. In other words, with respect to the usage position, the respective platform 30a-c can be fastened to the support frame 14 in the second spatial direction illustrated by the double arrow 26 by means of the frame fastening device and the respective platform fastening device in at least two mutually different positions of the respective platform 30a-c. Moreover, with respect to the usage position, the respective platform 30a-c can be fastened to the support frame 14 in the third spatial direction illustrated by the double arrow 28 by means of the frame fastening device and the respective platform fastening device in at least two mutually different positions of the respective platform 30a-c. For example, the respective fastening device is a mechanical fastening device, such that, for example, the respective platform 30a-c can be mechanically fastened, and thus fixed, in the respective positions relative to the holding frame 14, in particular in such a way that, in the respective position of the respective platform 30a-c, relative movements between the respective platform 30a-c and the holding frame 14 are avoided.

Furthermore, it is presently provided that the assembly platform 10 is adjustable in terms of height. For this purpose, the respective support element 16, 18 can be changed with respect to its respective length, which extends in the vertical direction when the holding frame 14 is supported downwards in a vertical direction on the floor 20 via the support elements 16 and 18, whereby a distance between the holding frame 14 and the floor 20, which runs in a vertical direction when the support frame 14 is supported downwards in a vertical direction on the floor 20 via the support elements 16 and 18, can be set, i.e., changed.

It can be seen particularly well from FIG. 3 that the respective support element 16, 18 has rungs 36 onto which the person can climb in order to thus reach the platform 30a, which is non-destructively detachably fastened to the holding frame 14, in particular while the assembly platform 10 is in its usage position shown in FIGS. 2 and 3.

In FIG. 2, an installation space of the vehicle, also referred to as the vehicle installation space, is labelled with 38. It can be seen that, for example, the person can kneel, sit, or lie on the respective platform 30a-c while carrying out the at least one working process, for example, on the platform 30a according to FIG. 2, and can here carry out the at least one working process without undesirable collisions or contact occurring between the person and the vehicle, in particular with vehicle components arranged in the installation space 38. Thus, damage to the vehicle can be avoided when carrying out the at least one working process.

The person supported downwards in the vertical direction on the platform 30a and thus via the assembly platform 10 on the floor 20 while carrying out the at least one working process is shown particularly schematically in FIG. 3 and labelled with 40. Moreover, in FIG. 3 installation spaces of the vehicle are shown with 42 and 44. It can also be seen from FIG. 3 that the person 40 can carry out the at least one working process while the person 40 is on the platform 30a without any undesired contact, touching, or collisions occurring between the person 40 and the vehicle, in particular with components of the vehicle arranged in the respective installation spaces 42, 44. Overall, it can be seen that the assembly platform 10 enables the person, who is, for example, a mechatronics engineer or a diagnostic technician, to carry out the at least one working process in a particularly advantageous, ergonomic, and thus comfortable position. For example, this enables the person to carry out at least one working process lying down or kneeling in close proximity to components that are to be processed, for example, during the working process. In particular, the person can reach the components particularly ergonomically and safely, thus accessing the components ergonomically and safely, whereby the working process can be carried out ergonomically, easily, and safely. Since the assembly platform 10 is an aid that is formed separately from the vehicle, the assembly platform 10 is decoupled from the vehicle. By decoupling the aid (assembly platform 10) from the vehicle in this way, it can be ensured that the person does not damage the vehicle when carrying out the at least one working process.

1.-7. (canceled)

8. An assembly platform (10) for supporting a person (40) when carrying out a working process on a vehicle, comprising:
a base frame (12) which has a holding frame (14) with a frame fastening device and support elements (16, 18) which are moveably held on the holding frame (14), wherein via the support elements (16, 18) the holding frame (14) and thus the assembly platform (10) is supportable downwards in a vertical direction (22) on a floor (20); and
at least two platforms (30a-c) which are formed separately from one another and separately from the base frame (12) and which each have a respective platform fastening device, wherein at least one platform of the at least two platforms (30a-c) is detachably, non-destructively fastenable to the holding frame (14) by the frame fastening device and the respective platform fastening device, wherein the at least one platform of the at least two platforms (30a-c) extends elongately and thus has a respective longitudinal extension direction (32);
wherein the at least one platform of the at least two platforms (30a-c) is fastenable to the holding frame (14) in the respective longitudinal extension direction (32) by the frame fastening device and the respective platform fastening device in at least two mutually different positions of the at least one platform of the at least two platforms (30a-c);
wherein the at least one platform of the at least two platforms (30a-c) is fastenable to the holding frame (14) in a respective direction (34) running perpendicularly to the respective longitudinal extension direction (32) by the frame fastening device and the respective platform fastening device in at least two mutually different positions of the at least one platform of the at least two platforms (30a-c), wherein the respective longitudinal extension direction (32) and the respective direction run on a common plane.

9. The assembly platform (10) according to claim 8, wherein the at least one platform of the at least two platforms (30a-c) is fastenable to the holding frame (14) by the frame fastening device and the respective platform fastening device in at least two mutually different positions of the at least one platform of the at least two platforms (30a-c).

10. The assembly platform (10) according to claim 8, wherein a respective length of the support elements (16, 18) is changeable such that a distance running in the vertical direction (22) between the holding frame (14) and the floor (20) is settable.

11. The assembly platform (10) according to claim 8, wherein at least one of the support elements (16, 18) has rungs (36) or steps.

12. The assembly platform (10) according to claim 8, wherein the holding frame (14) has a length which is changeable.

13. A method of using the assembly platform (10) according to claim 8, comprising the step of:
supporting the person (40) on the assembly platform (10) when the person (40) is carrying out the working process on the vehicle.

14. The method according to claim 13, wherein the person (40) lies, sits, or kneels on the at least one platform of the at least two platforms (30a-c) when carrying out the working process.
